(19) United States
(12) Patent Application Publication
(10) Pub. No.: US 2008/0294976 A1
(43) Pub. Date: Nov. 27, 2008

(54) System and method for generating and communicating digital documents

(76) Inventor: Eyal Rosenberg, Kfar Saba (IL)

Correspondence Address: Pearl Cohen Zedek Latzer, LLP, 1500 Broadway, 12th Floor, New York, NY, 10036, US

(21) Appl. No.: 11/802,311

(22) Filed: May 22, 2007

(51) Int. Cl. G06F 17/00; G06F 15/00; G06F 17/30

(52) U.S. Cl. 715/209; 707/104.1; 707/E17.019

(57) ABSTRACT

A document may be sent to a virtual printer which may be a software module configured as a print driver to receive the printer file, retrieve further information from a data repository, and produce a file including both the document image and additional information. The software module may further transmit the document to a central hub, from which it may be further processed and/or transmitted to an intended recipient.

### BACKGROUND OF THE INVENTION

Advancements in computing and communication technologies have enabled significant changes in the way businesses correspond with each other. Whereas electronic documents formerly confirmed or backed up formal paper documentation, in many organizations, such as businesses and government agencies, electronic business documents comprise the formal or official form of transacting business. A large number of variety of documents are regularly exchanged between agencies and business partners regardless of distance and geographic location.

Accordingly, today's businesses may be overwhelmed by the demands of business to business (B2B) correspondence and documentation, such as electronic issuance, handling, receipt, and/or transmission of invoices, purchase orders, shipping notes and other business or official documents. In many organizations, certain information may be required for compiling a given document, the document may need to be created in one of various formats, depending on the recipient, the document may need to be sent according to one of numerous formats or protocols, the document may need to be transmitted, for example, by electronic means. If the document contains an error, locating the error may be a timely and costly process.

There is a need for an improved system and method for producing, managing and/or communicating business and/or official documents.

### SUMMARY OF EMBODIMENTS OF THE INVENTION

Embodiments of the invention may be used to control, automate or otherwise assist in tasks associated with handling of business to business correspondence and/or documentation, for example, compiling, communicating, transmitting, receiving, and processing business to business documents. According to some embodiments of the invention, a document may be sent to a “virtual printer” which may be a software module configured to receive the printer file, retrieve further information from a data repository, and produce a file including both the document image and additional information. The software module may further transmit the document to a central hub, from which it may be further processed and/or transmitted to an intended recipient.

According to embodiments of the invention, a software module may generate an electronic document including both image and data information, through a print driver, where at least some of the data component may be extracted from an Enterprise Resource Planning (ERP) system based on information parsed out of the document header. This electronic document may then be digitally signed, and thereupon, transmitted to a correspondent, such as a business partner or to a central repository for further processing and transmission.

In particular, embodiments of the present invention may use a pre-existing printing function, for example, a print button in an ERP system, to produce an electronic document containing both document image and document data. A software module, configured as a printer driver may capture the image of the document, parse information from the document, and based on the parsing, collect required data from an enterprise resource planning (ERP) system. A digital signature may be affixed to the document or to portions thereof. These components may be encapsulated as an electronic document and manipulated, for example, add missing data or change date format, then transmitted to a business correspondent, or to a central repository for further processing.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is a flowchart of a business process according to an embodiment of the present invention.

FIG. 2 is a flowchart of a business process according to an embodiment of the present invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of stations” may include two or more stations.

Furthermore, the application makes reference to a business document or to an electronic document; however, it will be recognized that the technological teachings of the present invention may be applied to any context in which a formal document associated with or based upon an enterprise resource planning (ERP) system may be desired to be transmitted to a correspondent, for example, between government agencies, or from a government agency to its clients or constituents, etc. Accordingly, some applications of the present invention may include invoices, bills, purchase orders, shipping notes, payment receipts, official actions, etc.

Unless explicitly stated, the method embodiments described herein are not constrained to a particular order or sequence. Additionally, some of the described method embodiments or elements thereof can occur or be performed at the same point in time.

Typically, printing of a document by a user from within an application, for example, an ERP system, will comprise sending a document to a printer driver. A printer driver may be a software module used to creating binary or textual file, for example a PRN file, and sending that file to a printer. The pring file typically contains both data to be printed as well metadata. Metadata may typically contain information regarding printing attributes of the data, for example font size, font type, font color, font attributes, e.g., bold, italics, or underline, etc. Other information in the print file may include paper size, indentation, and orientation of the paper, e.g. landscape or portrait.

According to some embodiments of the present invention, the printing process may be used to produce an electronic document instead of or in addition to a printed document based on the application. The printing process may be broken down to sub-processes and functionalities.

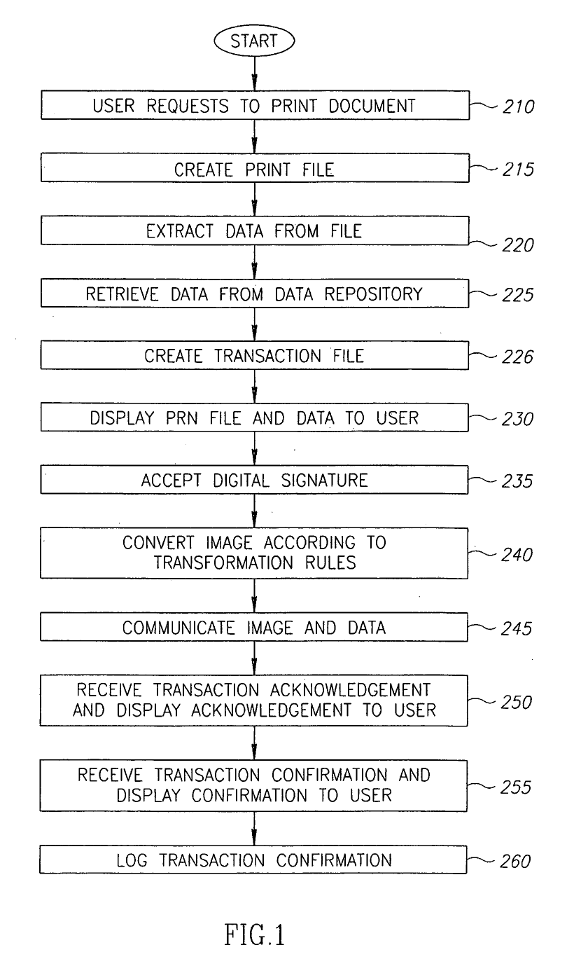

Reference is now made to FIG. 1 showing a flowchart of an exemplary process according to embodiments of the present invention. The process may begin by a user requesting to print a document (210). The request to print may be directed to a virtual printing device, for example, an “Invoice Printer”. A virtual printing device may be a software module that may appear as a printer or other printing device to a user and/or computer applications, however, need not be associated with a printing device or otherwise print a document. The virtual printer of the present invention may create a textual print file, but rather than send the print file to a printer, the virtual printing device may parse the file, extract required data and information from the print file, collect information from an ERP system based on the data extracted form the print file, extract the printed image and convert it to electronic image, wrap the extracted data and image of the printout into XML file, and send the resultant file through secured Web Service protocol to the central hub. In some embodiment of the invention, the virtual printer may provide the user with printing options through a “Properties” selection in the printing menu associated with the application. Any user application allowing a printing function may be compatible with the virtual printer of the present invention, for example, ERP package, finance application, a database, etc.

The user directing the printing of a document to the virtual printing device of the present invention may cause the creation of a printer file, for example, a .prn file (215). The information contained in the .prn file may be used to produce an image of the document as it would have been printed, had it been printed. This image may be saved in any suitable image format, for example, Joint Photographic Experts Group (.jpg), tagged image file format (.tiff), portable network graphics (.png), graphics interchange format (.gif), portable document format (.pdf), etc.

Based on the Printed file, the software module may extract data from the file (220). The process of extracting data from the file may involve locating relevant data in the file. For example, relevant data may be, document name, document identity, catalog numbers of listed items, quantities, prices of items, business partner's identification, and relevant dates. In some embodiments of the invention, the software module may be preconfigured to search for particular items, for example, using a list of items or item types to search for, or using a template associated with a type of document. For example, the virtual printer may search for a word in the header or at the top of a document, and based on this information, to find relevant items in the body of the document. For example, if the virtual printer finds the word “Invoice” at the top of a document, it may search through the document for item catalog numbers, quantities, prices, etc. based on an invoice template; whereas if the virtual printer finds the word “Purchase Order” at the top of a document, it may search for different items known to be associated with a purchase order document.

Data may be retrieved from a data repository (225). In some cases, the virtual printer may always retrieve certain information. In other cases, details obtained from the document may be used in order to determine what information is be retrieved from the data repository. The virtual printer may generate or construct queries or requests to back office applications, for example, an ERP system or a customer relationship management (CRM) system, in order to retrieve the required data. For example, an invoice number may be recognized and desired information pertaining to that invoice may be retrieved from the ERP. In another example, if the virtual printer recognized the document as an invoice, it may locate the customer in the document, find the customer information in the ERP or CRM database, and thereby locate the payment terms, e.g., 30 days or 60 days or 90 days, to be associated with the invoice based on the customer. In another example, a company may have a policy of ordering all items of a certain type by one method of shipment, for example, by next day air. Accordingly, if the document is a purchase order, the virtual printer may retrieve the item being ordered, and if it is of a certain type, the virtual printer will retrieve the shipping terms, for example, next day air shipping. The virtual printer may be configured or programmed to retrieve data from the data repository based on conditions or triggers in the content of the document being virtually printed.

Data from the body of the document and data retrieved from the ERP or CRM database may then be used to compile a transaction file (226) containing data relevant to the business process. The transaction file may omit printing information or other metadata included in the Print file, such as font size and color. Accordingly, business information, for example, item catalog numbers, quantities and the like, may appear in the transaction file whereas information such as font size, font type or font color may be omitted from the transaction file. The transaction file may be constructed according to a defined format. For example, in some embodiments of the invention, the transaction file may be constructed according to extensible markup language (XML), which allows for easy representation of practically any data type, as well as definition of hierarchies of data types, and data type definitions.

According to embodiments of the invention, the document image may be displayed to the user for approval (230). In some embodiments, the content of the transaction file may also be displayed to the user for review and approval. The image displayed to the user may be a graphical representation of the Print file, according to a predefined format.

The user may confirm or reject the displayed content (235). If the user rejects the transaction, the process may perform alternative procedures and processes as predefined in system setup, or the process may be aborted. In some embodiments, the user may correct certain information in the transaction file and/or the underlying document and reprocess the virtual printer process. The process may prompt the user for a parameter to be corrected. Such a parameter may be, for example, a business partner identification number or an invoice number. Using, for example, an invoice number, the process may communicate with a data repository, for example, an ERP system, and retrieve data relevant to the invoice number supplied. The information retrieved may be displayed to the user. Using the information in the ERP, the document may be modified, and the user may authorize the transaction. If the information is approved, the virtual printer may affix a digital signature or an electronic signature.

The process may convert data according to predefined rules and formats (240), for example, the data may be encrypted in order to enhance security. Encryption may be performed according to predefined rules, for example, encryption type may vary according to the destination of the transaction or the recipient type. In some cases, encryption may be dictated by rules and regulation, for example, in government agencies. Another form of conversion may be compressing data in order to save network resources. For example, compression may be performed according to predefined rules, for example, a business partner may prefer to receive data which was compressed in a particular format, in such case the process may be so configured as to compress data to be sent to that specific business partner according to the preferred format. Another example of conversion may involve a business partner who expects data to be organized according to particular order, data may be reorganized according to a predefined rule pertaining to that specific business partner. In some embodiments of the invention, some parts of the data may need to be removed from the transaction file before transaction, for example when some of the information retrieved from a back office application pertaining a business partner is confidential.

Upon completion of the processing, the data and image may be communicated (245), for example, to a business partner or correspondent, a client, supplier, etc., or to a central repository, which may then process and deliver the document to its final destination. It will be recognized that an electronic document may be sent simultaneously or contemporaneously to multiple recipients, for example, a client contact and an accounting department at a single company, or to multiple companies. Furthermore, the data may be communicated to one or more recipients within the organization as well as one or more recipients outside the organization. Communicating the data to recipients within the organization may be done, for example, for logging or monitoring purposes. Communication of the data may be done by various means such as but not limited to, private IP network, the internet, integrated services digital network (ISDN) line, a frame relay connection, or a modem connected to a phone line.

The communication may be acknowledged by the receiving end, the acknowledgment may be propagated back to the sending process, where it may be shown to the user (250) to inform the user that the transaction has reached its destination. In the case where transaction is to an intermediary node, acknowledgments may provide the user with information regarding the progress of the transaction, for example, each node along the path connecting the sending side with the receiving side may generate an acknowledgement back to the sending process.

A user at the receiving end may further confirm receipt of the transaction, the confirmation may be propagated back to the sending side where it may be displayed to the user (255). Confirmation by the user at the receiving side may be done in various ways, for example, a button provided by the application may be pressed, additionally, the user at a receiving side may attach text or data to the confirmation, these text or data may be conveyed back to the sending process and displayed to the user.

The process may log the completion (or non-completion) of any step in the process (260). The process of logging, e.g., what steps to log, may depend on the type or content of the document and/or on the application sending the document to the virtual printer. Logging may be, for example, with an ERP system or a CRM system.

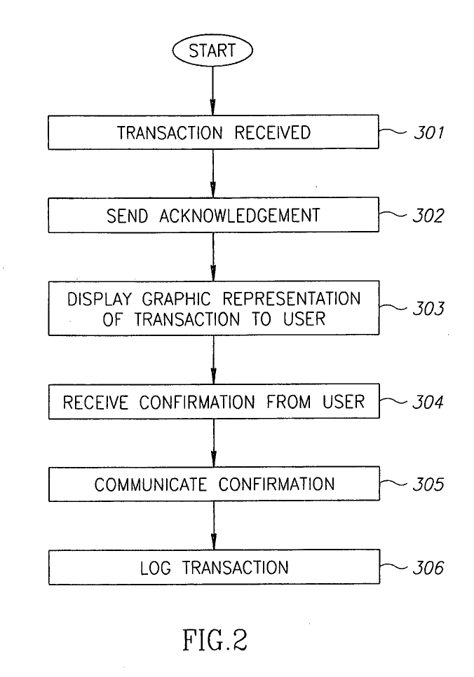

Reference is now made to FIG. 2 which is a flowchart of an exemplary process according to embodiments of the present invention. This flow may take place at a receiving side of the process. An electronic document according the embodiments of the invention may be received (301). The process may verify the document as well as the transaction. Verification of the transaction may comprise checking that the document reached the correct destination, the process may further verify that the source of the transaction is not in some black-list of the receiving end. Verification of the document may be, for example, checking for compliance with a predefined format of the document, as well as the existence or nonexistence of predefined data in possibly predefined locations within the document.

An acknowledgment may be sent back to the originator of the transaction (302). Optionally, in case an error is detected, or verification in step (301) fails, an error message may be sent back to the originator of the transaction. In some embodiments, the content received may be converted to a graphical representation and displayed to a user (303). In some embodiments of the invention, transaction of data is done using XML, in this case, step (303) may involve generating an image of the data contained in an XML document received. The graphical representation may be according to a predefined format, for example HTML may be used to display the content received, other examples of display formats may be Joint Photographic Experts Group (.jpg), tagged image file format (.tiff), portable network graphics (.png), graphics interchange format (.gif), or portable document format (.pdf).

The flow may then proceed by receiving a confirmation of receipt from the user (304), a confirmation may be done using a button provided by the application, alternatively the user may choose to reject the transaction, in which case the process may send an error message to the originator of the transaction. The process may communicate the confirmation back to the originator of the transaction (305), the confirmation may be encrypted by the process prior to being sent, encryption may be done for security or privacy reasons. The process then may end by logging the confirmed transaction (306). Logging may depend on applications and services used by the relevant site, examples may be logging with an ERP system or a CRM system. Data for logging may be collected throughout the process and may be saved either at the end of the process or alternatively during process execution.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method for generating a composite document comprising:
receiving a print file containing printer control data and document content data;
creating an image representation of said print file based on printer control data and document content data contained in said print file;
obtaining from a database system data pertaining to said print file; and
creating a composite document including said image representation, said document content data, and said system data.

2. The method of claim 1, further comprising:
displaying said image representation, document content data, and said system data to a user for review; and
if said image representation, said document content data, and said system data are acceptable to said user, affixing a signature to said composite document.

3. The method of claim 1, wherein said database is associated with a back-office application selected from the group consisting of a client relations management system, an enterprise resource planning system, and a Web service interface.

4. The method of claim 1, wherein said composite document is selected from the group consisting of an invoice, a purchase order, and a shipping note.

5. The method of claim 1, wherein said system data is obtained based on rules selected based on said document content data.

6. The method of claim 1, further comprising transmitting said composite document to a destination.

7. The method of claim 6, further comprising recording said transmission.

8. The method of claim 6, further comprising receiving from said destination confirmation of said transmission.

9. The method of claim 8, further comprising recording said receipt of said confirmation.

10. An article of manufacture for use in a computer system, the article of manufacture comprising a computer usable medium having computer readable program code means embodied in the medium, the program code including computer readable program code that when executed causes a computer to:
receive a print file containing printer control data and content data;
create an image representation of said print file based on printer control data and document content data contained in said print file;
obtain from a database system data pertaining to said print file; and
create a composite document including said image representation, said document content data, and said system data.

11. The article of claim 10, wherein the computer readable program code when executed causes a computer to further:
display said image representation, said document content data, and said system data to a user for review; and
if said image representation, said document content data, and said system data are acceptable to said user, affix a signature to said composite document.

12. The article of claim 10, wherein said database is associated with a back-office application selected from the group consisting of a client relations management system, an enterprise resource planning system, and a Web service interface.

13. The article of claim 10, wherein said composite document is selected from the group consisting of an invoice, a purchase order, and a shipping note.

14. The article of claim 10, wherein said system data is obtained based on rules selected based on said document content data.

15. The article of claim 10, wherein the computer readable program code when executed causes a computer to further transmit said composite document to a destination.

16. The method of claim 15, further comprising recording said transmission.

17. The method of claim 15, further comprising receiving from said destination confirmation of said transmission.

18. The method of claim 17, further comprising recording said receipt of said confirmation.

19. A method for processing a composite document comprising:
receiving a composite document containing data and an image representation of at least part of said data;
displaying said image representation to a user;
receiving from said user confirmation of said image representation; and
recording in a database information extracted from said data in said composite document.

20. The method of claim 19, further comprising transmitting a receipt acknowledgment to a sender of said composite document.

21. The method of claim 20, further comprising recording information pertaining to said transmission of said receipt acknowledgment of said composite document.

22. The method of claim 20, further comprising transmitting said user confirmation to said sender of said composite document.

23. The method of claim 22, further comprising recording information pertaining to said transmission of said user confirmation of said composite document.

24. The method of claim 19, wherein said database is associated with a back-office application selected from the group consisting of a client relations management system, a Web service interface, and an enterprise resource planning system.

25. The method of claim 19, wherein said composite document is selected from the group consisting of an invoice, a purchase order, and a shipping note.

26. The method of claim 19, wherein said extracted information is obtained based on rules selected based on said composite document.

27. An article of manufacture for use in a computer system, the article of manufacture comprising a computer usable medium having computer readable program code means embodied in the medium, the program code including computer readable program code that when executed causes a computer to:
receive a composite document containing data and an image representation of at least part of said data;
display said image representation to a user;
receive from said user confirmation of said image representation; and
record in a database information extracted from said data in said composite document.

28. The article of claim 27, wherein said computer readable program code when executed further causes said computer to transmit a receipt acknowledgment to a sender of said composite document.

29. The article of claim 28, wherein said computer readable program code when executed further causes said computer to record information pertaining to said transmission of said receipt acknowledgment of said composite document.

30. The article of claim 28, wherein said computer readable program code when executed further causes said computer to transmit said user confirmation to said sender of said composite document.

31. The article of claim 30, wherein said computer readable program code when executed further causes said computer to record information pertaining to said transmission of said user confirmation of said composite document.

32. The article of claim 27, wherein said database is associated with a back-office application selected from the group consisting of a client relations management system, a Web service interface, and an enterprise resource planning system.

33. The article of claim 27, wherein said composite document is selected from the group consisting of an invoice, a purchase order, and a shipping note.

34. The article of claim 27, wherein said extracted information is obtained based on rules selected based on said composite document.
